(19) United States
(12) Patent Application Publication
(10) Pub. No.: US 2006/0015476 A1
(43) Pub. Date: Jan. 19, 2006

(54) Driver program, recording medium on which driver program is recorded, driver control method, and driver control apparatus

(75) Inventor: Toshihiro Ueno, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/177,980

(22) Filed: Jul. 8, 2005

(30) Foreign Application Priority Data
Jul. 13, 2004 (JP) 2004-206344

(51) Int. Cl. G06F 17/30

(52) U.S. Cl. 707/1

(57) ABSTRACT

Provided is/are user settings database(s) storing name(s) and application information indicating application(s) within which setting of data processing condition(s) took place, these being attached to combination(s) of data processing condition setting(s) enterable or designatable at settings screen(s) appearing by way of user interface(s) and permitting setting of data processing condition(s), user interface(s) acquiring application information indicating application(s) within which opening of settings screen(s) took place and searching user settings database(s) based on acquired application information and selecting and displaying in list form name(s) saved in association with such application information; upon selection of arbitrary name(s) from among name(s) displayed in list form, content of data processing condition setting(s) at settings screen(s) is altered in accordance with combination(s) of data processing condition setting(s) associated with such name(s)

### BACKGROUND OF INVENTION

This application claims priority under 35 USC 119(a) to Patent Application No. 2004-206344 filed in Japan on 13 Jul. 2004, the content of which is hereby incorporated herein by reference in its entirety.

The present invention relates to driver program(s), recording medium or media on which driver program(s) is/are recorded, driver control method(s), and driver control apparatus(es), any of which may cause execution of processing of data by way of user interface(s) in accordance with request(s) from application(s).

Printer drivers are currently capable of implementing combinations of pluralities of print function settings to achieve a wide variety of types of finishing processing. Furthermore, users may employ any of a large number of applications depending on their intended purpose, and it is to be expected that the preferred printing method may vary depending on that purpose.

For this reason, besides printer default settings, conventional driver settings screens permit combinations of some number of print function settings to be saved (see, e.g., Japanese Patent Application Publication Kokai No. H8-147118 (1996)).

Japanese Patent Application Publication Kokai No. H8-147118 (1996) describes an information processing apparatus constructed such that, when a printer driver is launched pursuant to print request instructions from any of various applications to a printer, a central processing unit causes print settings information registered at storage means to be retrieved in accordance with application name and causes a print settings screen to be displayed at a display device in the event that it is determined that the application name is registered, but a central processing unit causes a print settings screen based on created default print settings information to be displayed at a display device in the event that it is determined that the application name is not registered. That is, art is disclosed which is such that in the event that the name of the application from which printing takes place matches a registered application name, print function settings previously saved under that application name are used as default settings.

However, such combinations of print function settings are saved without regard to the applications used. For this reason, it sometimes being the case that print function settings suited for use in one application will be unsuited for use as print function settings in another application, it may be the case that such print function settings would be incapable of being employed (printing cannot be carried out) or that such print function settings would produce undesirable print results were they to be used in the other application.

Furthermore, where a user utilizes the foregoing print functions to print documents from a large number of applications, there has been the problem that while it might be possible for setting of a wide variety of print functions to be carried out depending on the purpose of printing to be performed, the user would be hard pressed to find the desired settings thereamong when these are all simply saved in sequence.

The present invention was conceived in order to solve such problems, it being an object thereof to provide a driver program, recording medium on which driver program(s) is/are recorded, driver control method, and driver control apparatus which, as a result of attachment, to combination(s) of settings for data processing conditions (e.g., what is referred to as “print functions” in the context of the foregoing conventional art) saved by user(s), of name(s) indicating characteristic(s) thereof as well as information indicating application(s) from which setting of data processing conditions took place, permits selection of combination(s) of print function settings from list(s) of name(s) during the next and subsequent instance(s) when setting of data processing conditions is carried out; and which, as a result of control of content displayed in list(s) based on application(s) within which opening thereof takes place, easily permits setting of effective data processing conditions in different fashion for different applications.

### SUMMARY OF INVENTION

In order to solve the foregoing and/or other problems, a driver program in accordance with one or more embodiments of the present invention may cause execution of processing of data by way of one or more user interfaces in accordance with one or more requests from one or more applications, the driver program comprising one or more information acquiring steps in which one or more user settings databases storing one or more records is or are used to acquire an application information indicating one or more applications within which opening of one or more settings screen or screens took place, at least one of the settings screen or screens appearing by way of at least one of the user interface or interfaces and permitting setting of one or more data processing conditions, and each of at least a portion of the record or records containing, attached to one or more combinations of one or more data processing condition settings enterable or designatable at at least one of the settings screen or screens, one or more names and the application information indicating one or more applications within which setting of at least one of the data processing condition or conditions took place; one or more selection display steps in which at least one of the user settings database or databases is searched based on acquired the application information to select and display in list form at least one of the name or names saved in association with such the application information; and one or more settings altering steps in which one or more arbitrary names is or are selected from among at least one of the name or names displayed in list form to alter content of at least one of the data processing condition setting or settings in accordance with at least one of the combination or combinations of data processing condition setting or settings associated with such the name or names, such altered content being incorporated into at least one of the settings screen or screens. Furthermore, a driver program in accordance with embodiment(s) of the present invention may further comprise one or more save steps in which, in the event that one or more users carry out one or more procedures in which one or more arbitrary names is or are attached to at least one of the combination or combinations settable at at least one of the settings screen or screens by way of at least one of the user interface or interfaces, at least one of the record or records is or are saved to at least one of the user settings database or databases, each of at least a portion of the record or records containing, attached to at least one of the data processing condition settings at least one of the combination or combinations, at least one of the name or names and the application information indicating one or more applications within which setting of at least one of the data processing condition or conditions took place.

In accordance with embodiment(s) of the present invention having such feature(s), it is possible to quickly select combination(s) of function(s), a large number of which may be registered, by selecting arbitrary name(s) from among name(s) displayed in list form. Furthermore, by restricting display to combination(s) associated with application(s) carrying out data processing (e.g., printing processing), it is possible to make use of setting(s) (e.g., print setting(s)) suited to the particular situation.

Furthermore, a driver program in accordance with embodiment(s) of the present invention may be such that at least one of the save step or steps further comprises one or more inquiry steps in which one or more inquiries is or are made as to whether at least one of the data processing condition settings combination or combinations is also to be used within one or more other applications; and in the event that in response to at least one of the inquiry or inquiries it is selected that at least one of the data processing condition settings combination or combinations is also to be used within one or more other applications, information indicating usage within at least one of the other application or applications is attached thereto. Furthermore, in accordance with embodiment(s) of the present invention, at least one of the selection display step or steps may be such that, in the event that information indicating usage within at least one of the other application or applications is found to be attached thereto during searching of at least one of the user settings database or databases, one or more names saved in association with such attached information is or are also selected and displayed in list form. Adoption of such a constitution makes it possible for frequently used combination(s) of function(s) to be made candidate(s) for selection regardless of application.

Furthermore, in accordance with embodiment(s) of the present invention, at least one of the selection display step or steps may be such that different display order is employed for at least one of the name or names associated with application information indicating at least one of the application or applications within which opening of at least one of the settings screen or screens took place versus for at least one of the name or names associated with information indicating usage within at least one of the other application or applications. As example of display order that could be employed in such case, at least one of the name or names associated with application information indicating at least one of the application or applications within which opening of at least one of the settings screen or screens took place may, for example, be displayed in superior fashion, and at least one of the name or names associated with information indicating usage within at least one of the other application or applications may, for example, be displayed in inferior fashion with respect thereto.

Adoption of such a constitution makes it possible for combination(s) of the data processing condition setting(s) set at application(s) carrying out printing, for example, to be displayed such that same is/are listed in superior position(s) facilitating selection thereof, and for combination(s) of the data processing condition setting(s) set at other application(s) to be displayed such that same is/are listed in inferior position(s) with respect thereto, making it possible for combination(s) of the data processing condition setting(s) which is/are favorable to be easily selected even where many combinations of the data processing condition settings have been saved.

Furthermore, in accordance with embodiment(s) of the present invention, at least one of the selection display step or steps may be such that different display format is employed for at least one of the name or names associated with application information indicating at least one of the application or applications within which opening of at least one of the settings screen or screens took place versus for at least one of the name or names associated with information indicating usage within at least one of the other application or applications. As example of display formats that could be employed in such case, different display densities and/or display colors might be employed for at least one of the name or names associated with application information indicating at least one of the application or applications within which opening of at least one of the settings screen or screens took place versus for at least one of the name or names associated with information indicating usage within at least one of the other application or applications. Adoption of such a constitution makes it possible to easily distinguish print function setting(s) suited to application(s) carrying out printing, for example.

Furthermore, embodiment(s) of the present invention may further comprise one or more frequency counting steps in which, in the event that at least one of the data processing condition settings combination or combinations displayed at at least one of the settings screen or screens is used for data processing, at least one number of times that same is used is counted; and at least one of the selection display step or steps is such that at least one of the name or names displayed at at least one of the settings screen or screens is displayed in order of the number of times used. Adoption of such a constitution makes it possible for frequently used combination(s) of the data processing condition setting(s) to be listed in position(s) facilitating selection thereof, making it possible for combination(s) of the data processing condition setting(s) which is/are favorable to be easily selected even where many combinations of the data processing condition settings have been saved.

Furthermore, in accordance with embodiment(s) of the present invention, at least one of the save step or steps may be such that it is possible for a plurality of sets of application information to be associated with any one of at least one of the data processing condition settings combination or combinations. Adoption of such a constitution makes it possible, e.g., where print function setting(s) is/are effective for a plurality of applications, to eliminate need to register the same print function setting(s) for each of a number of application(s), permitting reduction in the number of registered instances of print function setting(s).

Furthermore, in accordance with embodiment(s) of the present invention, at least one of the save step or steps may further comprise one or more inquiry steps in which, in the event that at least one of the data processing condition settings combination or combinations is associated with application information indicating one or more applications other than any one of at least one of the application or applications requesting data processing, and at least one of the data processing condition settings combination or combinations associated with at least one of the other application or applications is used to cause execution of data processing, one or more inquiries is or are made as to whether at least one of the data processing condition settings combination or combinations is to be saved in association with application information for the one application; and in the event that in response to at least one of the inquiry or inquiries it is selected that saving is to be done in association therewith, at least one of the data processing condition settings combination or combinations, at least one of the name or names attached to at least one of the data processing condition settings combination or combinations, and at least a portion of the application information for the one application are saved to at least one of the user settings database or databases in mutually associated fashion. Adoption of such a constitution makes it possible, where data processing condition setting(s) registered for particular application(s) is/are also effective for other application(s), to permit such setting(s) to be quickly selected on subsequent occasion(s) without having to register the same combination(s) a plurality of times.

Furthermore, in accordance with embodiment(s) of the present invention, driver program(s) having constitution as described above may be provided in recorded form on computer-readable recording medium/media.

Furthermore, a driver control method in accordance with one or more embodiments of the present invention may cause execution of processing of data by way of one or more user interfaces in accordance with one or more requests from one or more applications, the driver control method comprising one or more information acquiring operations in which one or more user settings databases storing one or more records is or are used to acquire an application information indicating one or more applications within which opening of one or more settings screen or screens took place, at least one of the settings screen or screens appearing by way of at least one of the user interface or interfaces and permitting setting of one or more data processing conditions, and each of at least a portion of the record or records containing, attached to one or more combinations of one or more data processing condition settings enterable or designatable at at least one of the settings screen or screens, one or more names and the application information indicating one or more applications within which setting of one or more data processing conditions took place; one or more selection display operations in which at least one of the user settings database or databases is searched based on the acquired application information to select and display in list form at least one of the name or names saved in association with such the application information; and one or more settings altering operations in which one or more arbitrary names is or are selected from among at least one of the name or names displayed in list form to alter content of at least one of the data processing condition setting or settings in accordance with at least one of the combination or combinations of data processing condition setting or settings associated with such the name or names, such altered content being incorporated into at least one of the settings screen or screens.

In accordance with embodiment(s) of the present invention having such feature(s), it is possible to quickly select combination(s) of the data processing condition(s), a large number of which may be registered, by selecting arbitrary name(s) from among name(s) displayed in list form. Furthermore, by restricting display to combination(s) associated with application(s) carrying out data processing (e.g., printing processing), it is possible to make use of setting(s) for the data processing condition(s) (e.g., print setting(s)) which is/are suited to the particular situation.

Furthermore, a driver control apparatus in accordance with one or more embodiments of the present invention may cause execution of processing of data by way of one or more user interfaces in accordance with one or more requests from one or more applications, the driver control apparatus comprising one or more user settings databases storing one or more records; one or more information acquiring means for acquiring an application information indicating one or more applications within which opening of one or more settings screen or screens took place, at least one of the settings screen or screens appearing by way of at least one of the user interface or interfaces and permitting setting of one or more data processing conditions, and each of at least a portion of the record or records containing, attached to one or more combinations of one or more data processing condition settings enterable or designatable at at least one of the settings screen or screens, one or more names and the application information indicating one or more applications within which setting of one or more data processing conditions took place; one or more selection display means for searching at least one of the user settings database or databases based on the acquired application information and for selecting and displaying in list form at least one of the name or names saved in association with such the application information; and one or more settings altering means for selecting one or more arbitrary names from among at least one of the name or names displayed in list form and for altering content of at least one of the data processing condition setting or settings in accordance with at least one of the combination or combinations of data processing condition setting or settings associated with the such name or names, such altered content being incorporated into at least one of the settings screen or screens.

In accordance with embodiment(s) of the present invention having such feature(s), it is possible to quickly select combination(s) of the data processing condition(s), a large number of which may be registered, by selecting arbitrary name(s) from among name(s) displayed in list form. Furthermore, by restricting display to combination(s) associated with application(s) carrying out data processing (e.g., printing processing), it is possible to make use of setting(s) for the data processing condition(s) (e.g., print setting(s)) which is/are suited to the particular situation.

### BRIEF DESCRIPTION OF DRAWINGS

FIG. 1 is a drawing showing constitution of a print system employing a printer driver program, this being one example of a driver program in accordance with the present invention.

FIG. 2 is a functional block diagram of a user interface associated with the present embodiment.

FIG. 3 is an explanatory diagram showing examples of application information.

FIG. 4 is an explanatory diagram showing examples of print settings information.

FIG. 5 is a flowchart showing a sequence of processing such as might occur when a user saves a combination of print settings to a user settings database.

FIG. 6 is a flowchart showing a sequence of processing for display of a list of names of combinations of print settings capable of being used at an application that has opened a user interface.

FIG. 7 is a flowchart showing a sequence of processing such as might occur during selection of a combination of settings from a displayed list.

FIG. 8 is a flowchart showing a sequence of processing permitting setting so as to make it possible for settings at a particular application to be used at all applications, these being saved to a user settings database together with combinations of print settings.

FIG. 9 is a flowchart showing a sequence of processing for display of a list of names of combinations of print settings capable of being used at an application that has opened a user interface in a situation where these were registered for use at other application(s).

FIG. 10 is a flowchart showing a sequence of processing during display when a name is to be added to display of a list of functions for selection.

FIG. 11 is an explanatory diagram showing an example of a list display method.

FIG. 12 is a flowchart showing a sequence of processing for display of a list of names of combinations of print settings capable of being used at an application that has opened a user interface in a situation where the number of times used is saved.

FIG. 13 is a flowchart showing, in a situation where settings used for printing have not been associated with the application within which printing is carried out, a sequence of processing for registering such combination of print settings at a user settings database in association with application information indicating the application within which such printing is carried out.

### DESCRIPTION OF PREFERRED EMBODIMENTS

Below, embodiments of the present invention are described with reference to the drawings.

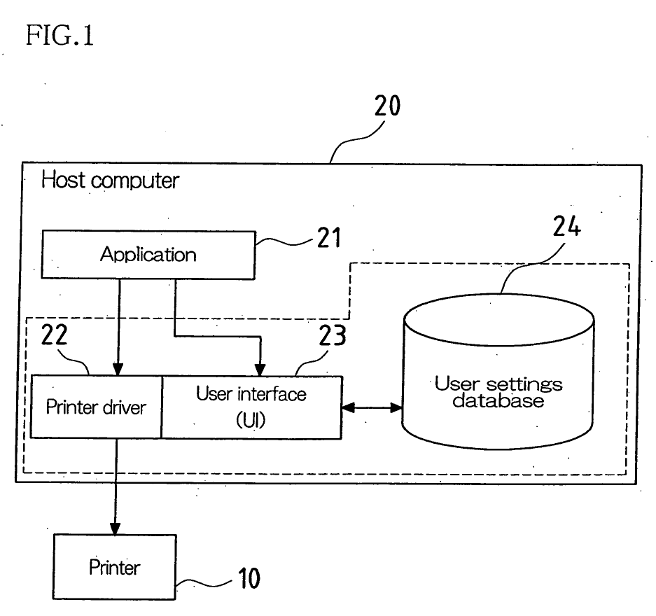

FIG. 1 is a drawing showing constitution of a print system employing a printer driver program, this being one example of a driver program in accordance with the present invention.

This print system is provided with host computer 20, and printer 10 which is connected to this host computer 20.

Host computer 20 is provided with group of application modules (hereinafter “application”) 21, these being programs which run on said host computer 20; and printer driver 22, which sends print request commands to printer 10 in accordance with print requests from application 21; and is provided with user interface 23 for entry and/or designation of print settings capable of being processed by printer driver 22. Also provided is user settings database 24 storing one or more records, each such record containing—attached to combination(s) of print function setting(s) (what is referred to in the context of the present invention as data processing condition setting(s)) enterable or designatable at settings screen(s) of user interface 23 permitting setting of print function(s) (what is referred to in the context of the present invention as data processing condition(s)—name(s) and application information indicating application(s) within which setting took place.

By causing user interface 23 to be displayed during printing in accordance with procedure(s) carried out by a user and by causing combination(s) of print function setting(s) designated (set) at settings screen(s) of user interface 23 to be communicated to printer driver 10, application 21 is capable of outputting print results reflecting print function settings as desired by the user.

At such time, information indicating the application 21 within which opening thereof takes place (more specifically, the filename of the application being executed) is used as condition at user interface 23 to retrieve combination(s) of print function setting(s) saved at user settings database 24, such retrieved combination(s) of print function setting(s) being used as basis upon which altering of print function settings item(s) will be carried out at settings screen(s) of user interface 23, permitting print function setting(s) previously carried out by user(s) to be reproduced at such settings screen(s).

Note that whereas printer driver 22, user interface 23, and user settings database 24 have for convenience of description been shown as separate functional blocks at FIG. 1, the portion enclosed within the broken line that includes all of these could actually be understood to run under the aegis of the “printer driver” as that term is used in its broadest sense.

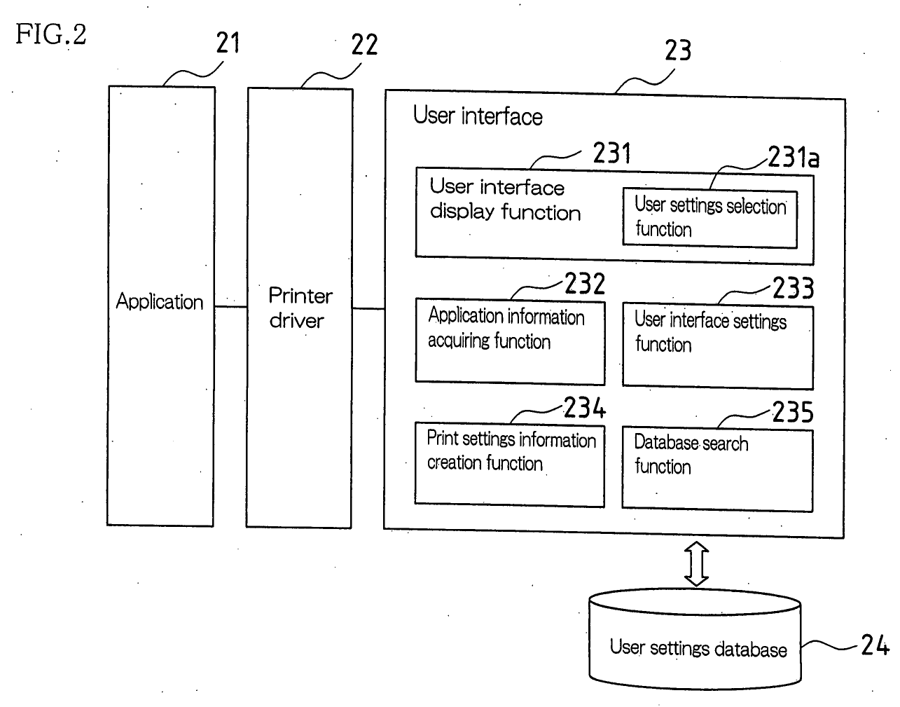

FIG. 2 is a functional block diagram of user interface 23 associated with the present embodiment.

User interface 23 of the present embodiment is provided with user interface display function 231 which is the ordinarily present screen display function, application information acquiring function 232 for acquiring application information indicating the application 21 within which user interface 23 was opened (filename of application being executed and/or the like), user interface settings function 233 for altering content of print function settings at user interface 23, print settings information creation function 234 for communicating information indicating what sort of printing should be carried out at application 21, and database search function 235 for searching user settings database 24 for combination(s) of print function setting(s) matching condition(s); furthermore, user interface display function 231 is provided with user settings selection function 231a for displaying lists(s) for selection of combination(s) of user setting(s).

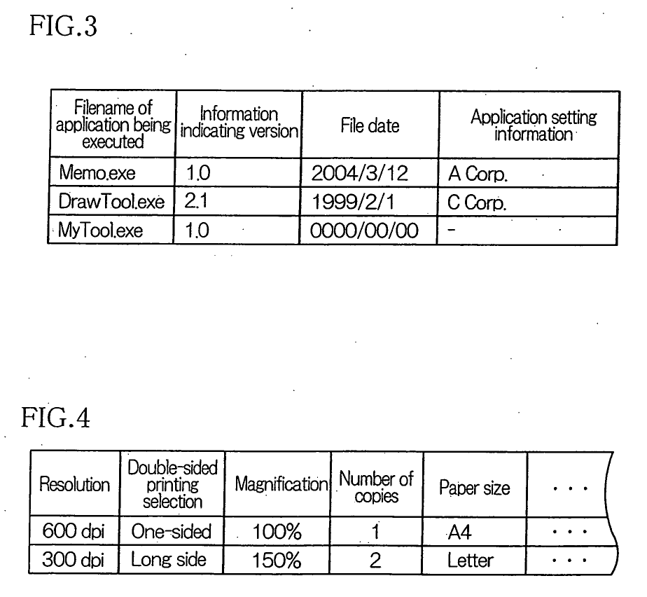

FIG. 3 shows examples of application information.

Application information might comprise such pieces of information as the filename of the application being executed, information indicating the version thereof, the date created, and the entity which created same. Note, however, that these are merely indicated by way of example, it being possible to use other information for same.

FIG. 4 shows examples of print settings information.

Resolution, double-sided printing selection, magnification, number of copies, paper size, and so forth may be cited as examples of print settings information. Furthermore, as many different types of information are conceivable depending on the capabilities of the printer driver(s) and the printer(s) itself/themselves, such print functions are not limited to the examples of information cited here.

Next described are working examples of various sequences of processing such as might be carried out when a user opens user interface 23 of printer driver 22 within application 21 at host computer 20 and enters and/or designates settings for various print functions at a settings screen in the context of a print system having constitution as described above.

### FIRST WORKING EXAMPLE

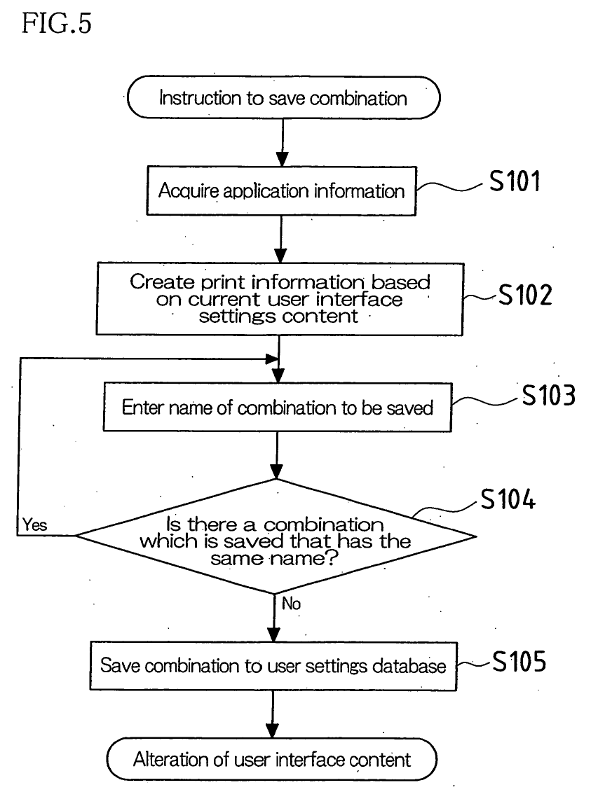

FIG. 5 is a flowchart showing a sequence of processing such as might occur when a user saves a combination of print function settings to user settings database 24. Referring to the flowchart shown in FIG. 5, described below is a sequence of processing by which a user might save a combination of print function settings to user settings database 24.

To wit, to carry out printing from application 21, user interface 23 is opened, current print function settings being displayed by means of user interface display function 231. The user carries out setting of print functions at a settings screen displayed by means of user interface display function 231; and upon selecting that such combination of settings should be saved, user interface 23 acquires, by means of application information acquiring function 232, information indicating which application it was that caused launching thereof to occur (step S101), and print settings information (the combination of print function settings) as set at the currently displayed screen is created by means of print settings information creation function 234 (step S102). Next, the user is prompted to enter a name for that combination of print function settings; and upon entry of the desired name (step S103), user settings database 24 is searched by means of database search function 235 to confirm whether a combination of print function settings was previously saved under the same name (step S1104). If as a result it is found that a different combination of print function settings has already been saved under the same name (“Yes” as determined at step S104), processing returns to step S103 where the user is again prompted to enter a name. But if it is found that a combination of print function settings has not been saved under that name (“No” as determined at step S104), identification information designated by the user, i.e., the name, and application information (filename of application being executed, information indicating version thereof, file date, application setting information, and/or the like) are saved (registered) to user settings database 24 together with the print settings information (step S105).

Thereafter, in the event that user interface 23 is again opened within the same application 21, user settings database 24 will be searched to find combination(s) of print function setting(s) matching the application information (filename of application being executed), name(s) given to such combination(s) of print function setting(s) being sequentially communicated to user settings selection function 231a and a list of combination(s) of print function setting(s) capable of being used within that application 21 being displayed at user interface 23.

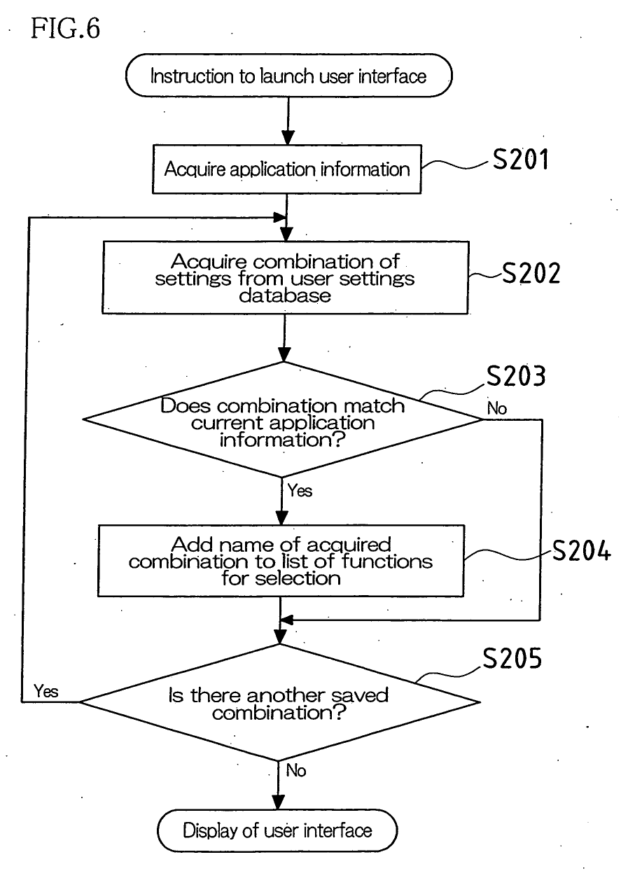

FIG. 6 is a flowchart showing processing at this time; i.e., a sequence of processing for display of a list of names of combinations of print function settings capable of being used at application 21 which has opened user interface 23. Referring to the flowchart shown in FIG. 6, described below is a sequence of processing for display of a list of names of combinations of print function settings.

To wit, upon opening of user interface 23 to carry out printing from application 21, user interface 23, by means of application information acquiring function 232, acquires information (filename of application being executed) indicating which application it was that caused launching thereof to occur (step S201). Next, combination(s) of print function setting(s) saved at user settings database 24 are acquired therefrom (step S202). In addition, determination is carried out as to whether information indicating the application that opened user interface 23 (filename of application being executed) is associated with combination(s) of print function setting(s) that were acquired from user settings database 24 (step S203). If as a result it is found that same is associated therewith (“Yes” as determined at step S203), name(s) given to such combination(s) of acquired print function setting(s) is/are added to the list of name(s) displayed by user settings selection function 231a (step S204). But if it is found that information indicating the application that opened user interface 23 is not associated therewith (“No” as determined at step S203), no addition is made to the list of name(s).

When such processing (steps S202 through S204) has been carried out for all of the combination(s) of print function setting(s) (i.e., such processing has been carried out until obtaining “No” as determined at step S205), all name(s) associated with the application 21 that opened user interface 23 to carry out printing will have been added to the list of name(s) displayed by user settings selection function 231a.

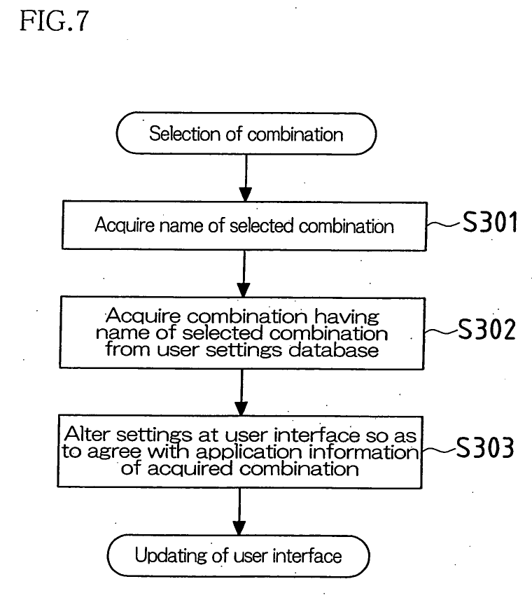

FIG. 7 is a flowchart showing a sequence of processing such as might occur during selection of a combination of print function settings from a list displayed in accordance with the sequence of processing at FIG. 6. Referring to the flowchart shown in FIG. 7, described below is a sequence of processing for selection, by a user, of a combination of print function settings from a list of displayed names.

To wit, when a user uses user settings selection function 231a of user interface display function 231 to select a name from among those displayed in list form, that name is acquired (step S301), causing the combination of print function settings having that name to be acquired from user settings database 24 by means of database search function 235 (step S302). In addition, user interface settings function 233 alters the content of print function setting(s) at the user interface to reflect the acquired information, i.e., the acquired combination of print function settings (step S303). That is, the content of print function settings that are currently being displayed is updated so as to be the combination of print function settings, the altered print function settings being displayed to the user by way of user interface display function 231.

Thereafter, when the user designates that setting of print functions has been completed, print settings information creation function 234 creates print settings information in accordance with content of print function settings existing at that time at the user interface, and communicates same to application 21. Application 21 uses print settings information passed thereto to carry out printing using printer driver 212.

This completes description of operations carried out during processing associated with a first working example of processing by which combinations of print function settings are saved in the print system of the present embodiment (FIG. 5), processing by which a list of names of combinations of print function settings capable of being used is displayed (FIG. 6), and processing by which content of print function settings is altered when an arbitrary name is selected from among the list of names (FIG. 7).

### SECOND WORKING EXAMPLE

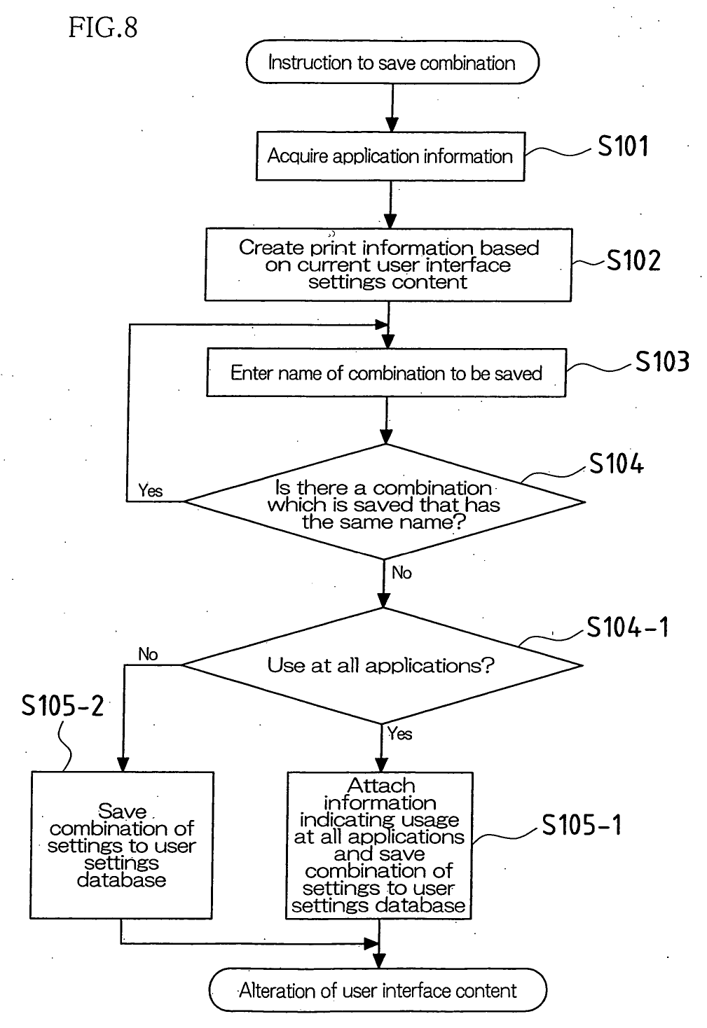

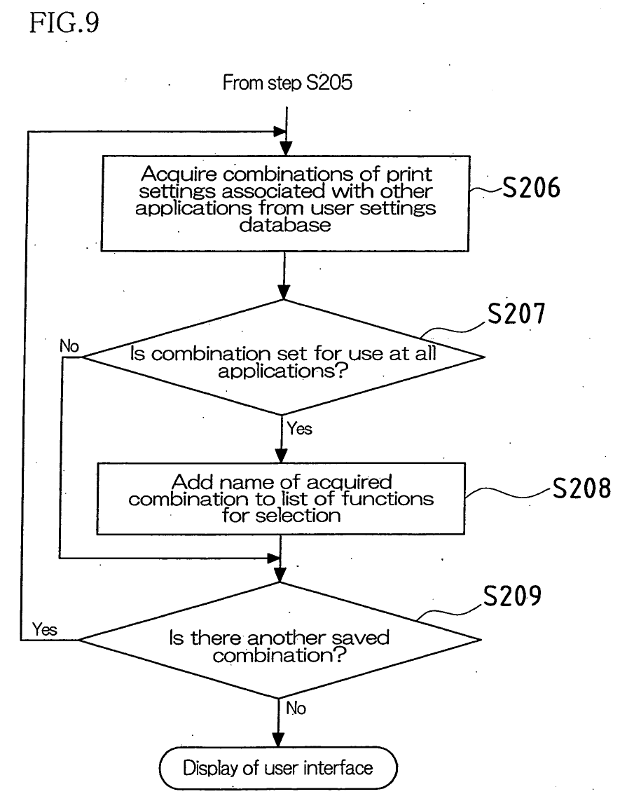

During display of combination(s) of print function setting(s) based on application information at the foregoing first working example, it may be the case that there is a request from a user indicating a desire that print function setting(s) used at particular application(s) also be used at other application(s). The present second working example is a working example of processing as might occur in such a case. Processing such as might take place in the present second working example is described below with reference to the flowcharts shown in FIGS. 8 and 9.

FIG. 8, corresponding to the flowchart shown in FIG. 5 at the foregoing first working example, is a flowchart showing a sequence of processing by which setting of print function(s) is carried out so as to make it possible for print function setting(s) at particular application(s) to be used at other application(s), combination(s) of setting(s) of print function(s) being carried out and saved to user settings database 24. The major difference between the flowchart shown in FIG. 8 and the flowchart shown in FIG. 5 is the fact that, at FIG. 8, step S104-1—a new evaluation step—has been added at a location corresponding to the location between step S104 and step S105 of FIG. 5. Referring to the flowchart shown in FIG. 8, described below is a sequence of processing by which setting is carried out so as to make it possible for print function setting(s) at particular application(s) to be used at other application(s), combination(s) of setting(s) of print function(s) being carried out and saved to user settings database 24.

To wit, to carry out printing from application 21, user interface 23 is opened, current print function settings being displayed by means of user interface display function 231. The user carries out setting of print functions at a settings screen displayed by means of user interface display function 231; and upon selecting that such combination of settings should be saved, user interface 23 acquires, by means of application information acquiring function 232, information indicating which application it was that caused launching thereof to occur (step S101), and print settings information (the combination of print function settings) as set at the currently displayed screen is created by means of print settings information creation function 234 (step S102). Next, the user is prompted to enter a name for that combination of print function settings; and upon entry of the desired name (step S103), user settings database 24 is searched by means of database search function 235 to confirm whether a combination of print function settings was previously saved under the same name (step S104). If as a result it is found that a different combination of print function settings has already been saved under the same name (“Yes” as determined at step S104), processing returns to step S103 where the user is again prompted to enter a name. But if it is found that a combination of print function settings has not been saved under that name (“No” as determined at step S104), confirmation is then carried out as to whether that combination of print function setting(s) should be used at all applications (step S104-1); and in the event that the user indicates that the setting(s) should be so used (“Yes” as determined at step S104-1), identification information designated by the user, i.e., the name, information indicating that setting(s) should be used at other application(s), and application information (filename of application being executed, information indicating version thereof, file date, application setting information, and/or the like) are saved (registered) to user settings database 24 together with the print settings information (step S105-1). But in the event that the user indicates at step S1104-1 that the setting(s) should not be so used (“No” as determined thereat), identification information designated by the user, i.e., the name, and application information (filename of application being executed, information indicating version thereof, file date, application setting information, and/or the like) are saved (registered) to user settings database 24 together with the print settings information (i.e., the combination of print function settings) (step S1105-2).

FIG. 9 is a flowchart, associated with the flowchart shown in FIG. 6 at the foregoing first working example, showing a sequence of processing for display of a list of names of combinations of print function settings capable of being used at an application 21 that opened user interface 23 in a situation where these were registered for use at other application(s) in accordance with the sequence of processing shown in FIG. 8. That is, the flowchart shown in FIG. 9 would be carried out following step S205 of the flowchart shown in FIG. 6. Referring to the flowchart shown in FIG. 9, described below is a sequence of processing for display of a list of names of combinations of print function settings.

To wit, following selection of all names corresponding to the application that opened user interface 23 during processing up to step S205, combination(s) of print function setting(s) associated with other application(s) is/are then acquired (step S206), and confirmation is carried out as to whether such combination(s) is/are set for use at all applications (step S207). If as a result it is found that such combination(s) is/are set for use at all application (“Yes” as determined at step S207), name(s) given to such combination(s) of print function setting(s) acquired at step S206 is/are acquired, and such name(s) is/are added to the list of name(s) displayed by user settings selection function 231a (step S208). When such processing (steps S206 through S208) has been carried out for all of the combination(s) of print function setting(s) having application information indicating other application(s) (i.e., such processing has been carried out until obtaining “No” as determined at step S209), all name(s) associated with the application 21 that opened user interface 23 to carry out printing, and all name(s) for which the application(s) indicated is/are different but which is/are set for use at all applications, will have been added to the list displayed by user settings selection function 231a.

As a result, it will also be possible to use combination(s) of print function setting(s) at application(s) other than the application(s) within which such combination(s) was/were saved.

### THIRD WORKING EXAMPLE

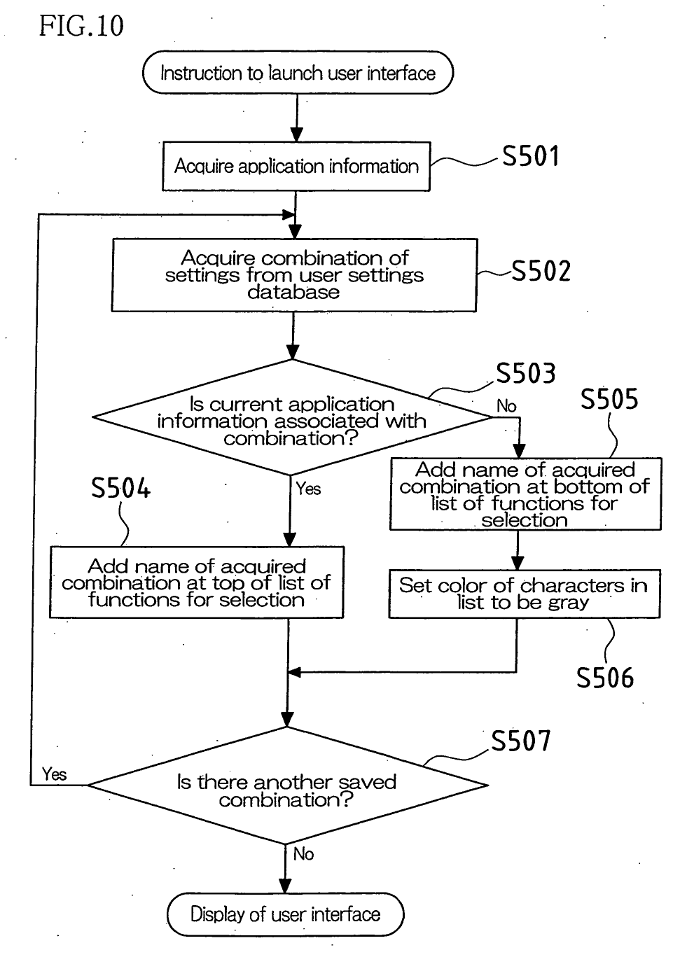

In the present third working example, determination is carried out as to whether application(s) carrying out printing is/are included among application(s) indicated by application information associated with combination(s) of print function setting(s) found as result of search of user settings database 24, combination(s) of print function setting(s) meeting this criterion being added at the top of the list of function(s) for selection, and combination(s) of print function setting(s) not meeting this criterion being added at the bottom of the list, so as to cause candidate(s) displayed toward the top of the list to be print function setting(s) suited to application(s) carrying out printing. Moreover, by varying some characteristic(s) depending upon whether the combination(s) of print function setting(s) is/are associated with the current application, it is possible in this working example to allow the user to quickly distinguish which thereamong is/are print function setting(s) suited to the application. Processing such as might take place in the present third working example is described below with reference to the flowchart shown in FIG. 10.

To wit, upon opening of user interface 23 to carry out printing from application 21, user interface 23, by means of application information acquiring function 232, acquires information (filename of application being executed) indicating which application it was that caused launching thereof to occur (step S501). Next, combination(s) of print function setting(s) saved at user settings database 24 are acquired therefrom (step S502). In addition, determination is carried out as to whether information indicating the application that opened user interface 23 (filename of application being executed) is associated with combination(s) of print function setting(s) that were acquired from user settings database 24 (step S503). If as a result it is found that same is associated therewith (“Yes” as determined at step S503), name(s) given to such combination(s) of print function setting(s) acquired from user settings database 24 is/are added at the top of the list of name(s) displayed by user settings selection function 231a (step S504). But if it is found that information indicating the application that opened user interface 23 is not associated therewith (“No” as determined at step S503), name(s) given to such combination(s) of print function setting(s) acquired from user settings database 24 is/are added at the bottom of the list of name(s) displayed by user settings selection function 231a (step S505). At this time, display is carried out such that display format of characters being displayed is different from display format of characters in name(s) added at the top (step S506). More specifically, color of characters displayed toward the top might in the present example be set so as to be black, while color of characters displayed toward the bottom might be set so as to be gray, red, or the like. The combination of black and gray would be an example of employment of different display densities, while the combination of black and red would be an example of employment of different display colors.

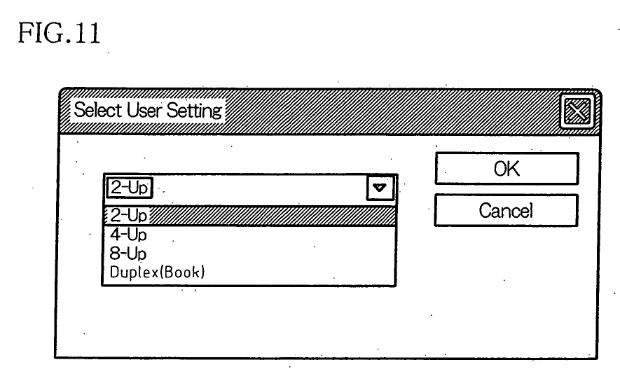

FIG. 11 shows an example of a list display method, name(s) (2-Up, 4-Up, 8-Up) associated with information indicating the application within which user interface 23 was opened being in the present example shown in black, and name(s) (Duplex (Book)) not associated therewith being in the present example shown in gray; however, any of a variety of display methods, e.g., varying background color, displaying icons, etc., might be employed instead.

When such processing (steps S502 through S506) has been carried out for all of the combination(s) of print function setting(s) (i.e., such processing has been carried out until obtaining “No” as determined at step S507), the list displayed by user settings selection function 231a will reflect different display formats such that name(s) of print function combination(s) set at application(s) carrying out printing is/are displayed so as to be listed in superior position(s) facilitating selection thereof, while name(s) of print function combination(s) set at other application(s) is/are displayed so as to be listed in inferior position(s) with respect thereto. As a result, even where many print function combinations have been saved, it will be possible for a user to more quickly and easily select favorable combination(s) of print function setting(s) as desired by the user.

### FOURTH WORKING EXAMPLE

In the present fourth working example, when displaying names in list form, the number of times that a combination of print function settings has been used (number of times printed) is taken into consideration, names being displayed in order such that combinations used many times are listed first. This being the case, in the present fourth working example, it will be necessary when a combination of print function settings is being set to count the number of times that same has been used, and to save same to user settings database 24. That is, following processing at step S303, i.e., following processing for altering content of print function setting(s) at the user interface to reflect acquired information indicating the acquired combination of print function settings during processing for selection by user(s) of combination(s) of print function setting(s) from a displayed list as shown in FIG. 7, processing is added by which information indicating incrementation (+1) in the number of times used is attached to the information indicating the combination of print function settings, this being used to update the information saved at user settings database 24. This makes it possible for information indicating the most recent number of times used to be attached to the combination of print function settings saved at user settings database 24.

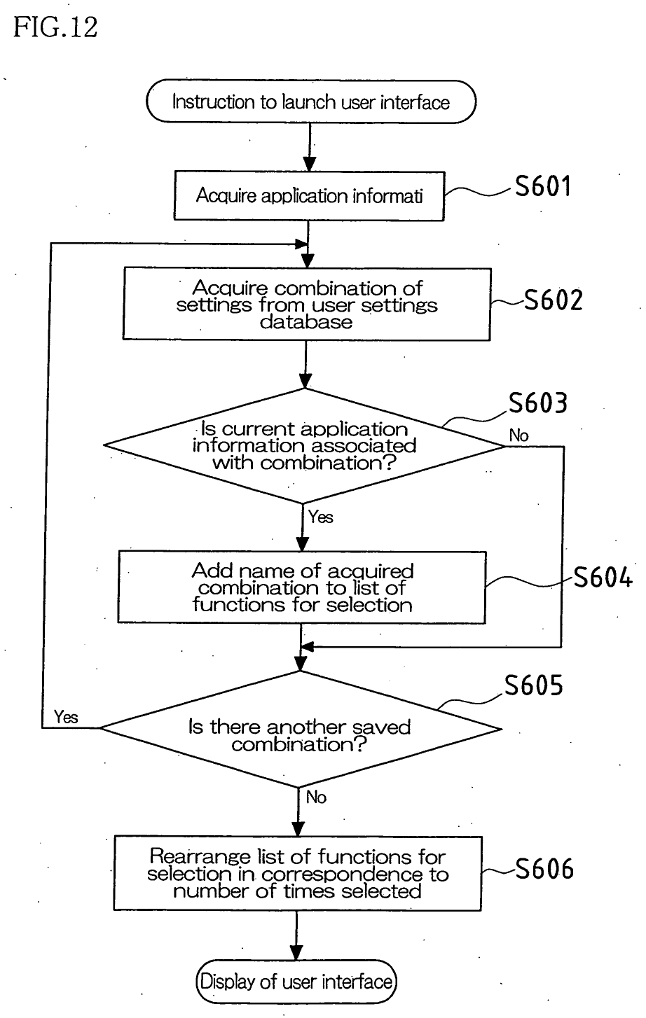

FIG. 12 is a flowchart showing a sequence of processing for display of a list of names of combinations of print function settings capable of being used at an application 21 that has opened user interface 23 in a situation where the number of times used is saved in the fashion described above. Referring to the flowchart shown in FIG. 12, described below is a sequence of processing for display of a list of names of combinations of print function settings.

To wit, upon opening of user interface 23 to carry out printing from application 21, user interface 23, by means of application information acquiring function 232, acquires information (filename of application being executed) indicating which application it was that caused launching thereof to occur (step S601). Next, combination(s) of print function setting(s) saved at user settings database 24 are acquired therefrom (step S602). In addition, determination is carried out as to whether information indicating the application that opened user interface 23 (filename of application being executed) is associated with combination(s) of print function setting(s) that were acquired from user settings database 24 (step S603). If as a result it is found that same is associated therewith (“Yes” as determined at step S603), name(s) given to such combination(s) of print function setting(s) acquired from user settings database 24 is/are added to the list of name(s) displayed by user settings selection function 231a (step S604). But if it is found that information indicating the application that opened user interface 23 is not associated therewith (“No” as determined at step S603), name(s) given to such combination(s) of print function setting(s) acquired from user settings database 24 is/are not added to the list of name(s).

When such processing (steps S602 through S604) has been carried out for all of the combination(s) of print function setting(s) (i.e., such processing has been carried out until obtaining “No” as determined at step S605), name(s) of print function combination(s) set at application(s) carrying out printing will have been added to the list of name(s) displayed by user settings selection function 231a. User interface display function 231 then extracts, from user settings database 24, the number of times used which is associated with each of the names displayed in list form, and rearranges the names such that they are listed in order of number of times used (step S606). As a result, even where many print function combinations have been saved, it will be possible for a user to easily select favorable print function combination(s) in correspondence to the number of times that same has/have been used.

Note that whereas in the foregoing fourth working example all names were displayed in list form, following which the number of times used was extracted from user settings database 24 and rearrangement was carried out, it is also possible to adopt a constitution which is such that when acquiring a name from user settings database 24 the number of times used is also acquired at the same time, rearrangement of the list being carried out with each addition thereto. Furthermore, management of number of times used may also be carried out separately for each application.

### FIFTH WORKING EXAMPLE

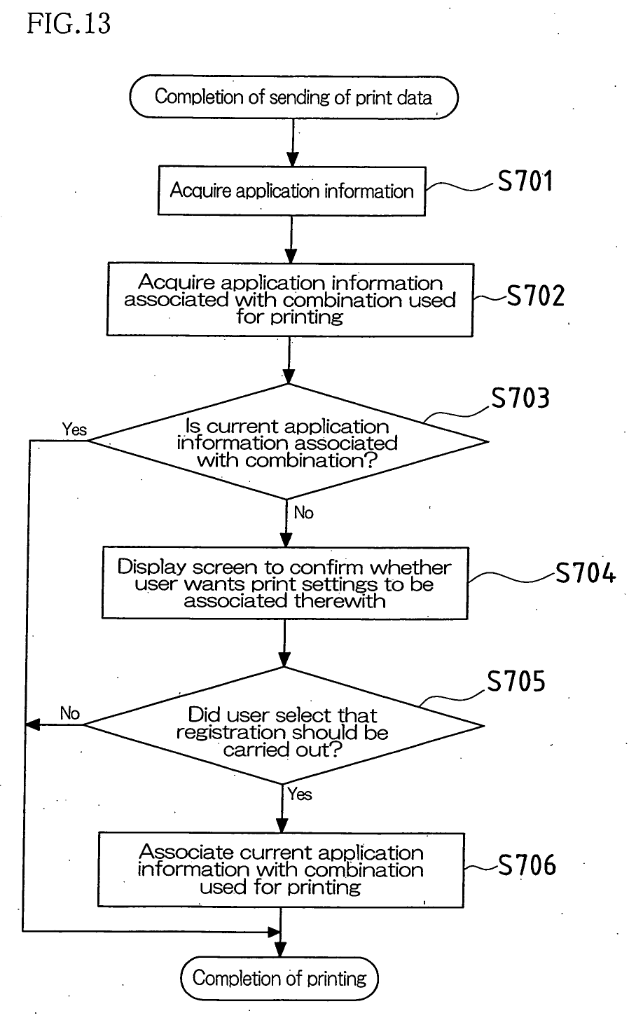

In the present fifth working example, where print function setting(s) used for printing has/have not been associated with the application within which printing was carried out, inquiry is made to the user as to whether such print function setting(s) should also be used following completion of printing; and in the event that the user determines that the combination of the application and the print function setting(s) would be useful, the combination of print function setting(s) and application information indicating the application within which such printing was carried out are registered in associated fashion at user settings database 24. FIG. 13 is a flowchart showing processing such as might occur at such a time. Processing such as might take place in the present fifth working example is described below with reference to the flowchart shown in FIG. 13.

To wit, after print data has been sent to printer 10, user interface 23, by means of application information acquiring function 232, acquires information (filename of application being executed) indicating the application within which printing was carried out (step S701). Next, application information associated with the combination of print function setting(s) just used to carry out printing is acquired from user settings database 24 (step S702). In addition, determination is carried out as to whether application information indicating the application within which printing was just carried out (filename of application being executed) matches application information associated with combination(s) of print function setting(s) acquired from user settings database 24 (step S703). If as a result it is found that the application information does not match (“No” as determined at step S703), application display function 231 causes a screen to be displayed to confirm whether application information indicating the application within which printing was just carried out should be associated with the combination(s) of print function setting(s) (step S704). In the event that the user indicates at this screen soliciting confirmation that association should be carried out (“Yes” as determined at step S705), the combination of print function setting(s) just used to carry out printing is saved to user settings database 24 in association with application information indicating the current application carrying out printing (step S706). As a result, during the next and subsequent instance(s) when printing is carried out, it will be possible for the combination of print function setting(s) to be treated in the same fashion as if registered within that application.

Note that whereas the foregoing working examples have been described in terms of an example employing a printer driver program as example of a driver program, the present invention is not limited to printer driver programs but may be applied in like fashion to any of a wide variety of driver programs.

One or more of the print systems described above is accomplished through a driver program which permits attachment, to combination(s) of setting(s) saved by user(s), of name(s) indicating characteristic(s) thereof as well as information indicating application(s) from which setting took place, and which permits selection of combination(s) of data processing condition(s) from list(s) of name(s) during the next and subsequent instance(s) when setting is carried out; and which, as a result of control of content displayed in list(s) based on application(s) within which opening thereof takes place, easily permits setting of effective data processing conditions in different fashion for different applications.

The subject of the invention may be such program(s) itself or themselves, and/or the subject of the invention may be such that such program(s) is/are stored on computer-readable recording medium/media.

In accordance with the present invention, such recording medium/media may take the form of memory or memories, not shown, necessary for carrying out processing at host computer 20 shown in FIG. 1, it being possible, for example, for memory such as ROM to itself serve as program medium/media; alternatively or in addition thereto, program-reading device(s) may be provided as external storage apparatus(es), not shown, such recording medium/media taking the form of program medium/media readable as a result of insertion of recording medium/media thereinto. Regardless of which of the foregoing situations applies, the constitution may be such that stored program(s) is/are accessed and executed by microcomputer(s); and/or a method may be employed in which program(s) is/are in any event read, read program(s) being loaded into program storage area(s) of microcomputer(s) before such program(s) is/are executed. Such program(s) to be loaded may be stored in advance at main apparatus(es).

Here, the foregoing program medium/media may be recording medium/media constructed so as to the separable from main body/bodies, and/or may be medium/media carrying program(s) in fixed form; including magnetic tape, cassette tape, and/or other such tape-type medium/media; FD (flexible disk) and/or HD (hard disk) and/or other such magnetic-disk- and/or CD-ROM/MO/MD/DVD and/or other such optical-disk-type medium/media; IC card (including memory card)/optical card and/or other such card-type medium/media; and/or mask ROM, EPROM, EEPROM, flash ROM, and/or other such semiconductor memory/memories.

Furthermore, in accordance with the present invention, where system architecture is such that connection(s) may be made to communication network(s) including the Internet, recording medium/media may carry program(s) in fluid form such that program(s) can be downloaded from communication network(s). Moreover, where program(s) is/are downloaded in such fashion from communication network(s), program(s) for performing such downloading may be stored in advance at apparatus main body/bodies or may be installed from other recording medium/media.

Moreover, the present invention may be embodied in a wide variety of forms other than those presented herein without departing from the spirit or essential characteristics thereof. The foregoing embodiments and working examples, therefore, are in all respects merely illustrative and are not to be construed in limiting fashion. The scope of the present invention being as indicated by the claims, it is not to be constrained in any way whatsoever by the body of the specification. All modifications and changes within the range of equivalents of the claims are, moreover, within the scope of the present invention.

What is claimed is:

1. A driver program causing execution of processing of data by way of one or more user interfaces in accordance with one or more requests from one or more applications, the driver program comprising:
one or more information acquiring steps in which one or more user settings databases storing one or more records is or are used to acquire an application information indicating one or more applications within which opening of one or more settings screen or screens took place, at least one of the settings screen or screens appearing by way of at least one of the user interface or interfaces and permitting setting of one or more data processing conditions, and
each of at least a portion of the record or records containing, attached to one or more combinations of one or more data processing condition settings enterable or designatable at at least one of the settings screen or screens, one or more names and the application information indicating one or more applications within which setting of at least one of the data processing condition or conditions took place;
one or more selection display steps in which at least one of the user settings database or databases is searched based on acquired the application information to select and display in list form at least one of the name or names saved in association with such the application information; and
one or more settings altering steps in which one or more arbitrary names is or are selected from among at least one of the name or names displayed in list form to alter content of at least one of the data processing condition setting or settings in accordance with at least one of the combination or combinations of data processing condition setting or settings associated with such the name or names, such altered content being incorporated into at least one of the settings screen or screens.

2. A driver program in accordance with claim 1 further comprising:
one or more save steps in which, in the event that one or more users carry out one or more procedures in which one or more arbitrary names is or are attached to at least one of the combination or combinations settable at at least one of the settings screen or screens by way of at least one of the user interface or interfaces, at least one of the record or records is or are saved to at least one of the user settings database or databases, each of at least a portion of the record or records containing, attached to at least one of the data processing condition settings at least one of the combination or combinations, at least one of the name or names and
the application information indicating one or more applications within which setting of at least one of the data processing condition or conditions took place.

3. A driver program in accordance with claim 2 wherein at least one of the save step or steps further comprises:
one or more inquiry steps in which one or more inquiries is or are made as to whether at least one of the data processing condition settings combination or combinations is also to be used within one or more other applications; and in the event that in response to at least one of the inquiry or inquiries it is selected that at least one of the data processing condition settings combination or combinations is also to be used within one or more other applications, information indicating usage within at least one of the other application or applications is attached thereto.

4. A driver program in accordance with claim 3 wherein at least one of the selection display step or steps is such that, in the event that information indicating usage within at least one of the other application or applications is found to be attached thereto during searching of at least one of the user settings database or databases, one or more names saved in association with such attached information is or are also selected and displayed in list form.

5. A driver program in accordance with claim 4 wherein at least one of the selection display step or steps is such that different display order is employed for at least one of the name or names associated with application information indicating at least one of the application or applications within which opening of at least one of the settings screen or screens took place versus for at least one of the name or names associated with information indicating usage within at least one of the other application or applications.

6. A driver program in accordance with claim 5 wherein the display order is such that at least one of the name or names associated with application information indicating at least one of the application or applications within which opening of at least one of the settings screen or screens took place is displayed in superior fashion, and at least one of the name or names associated with information indicating usage within at least one of the other application or applications is displayed in inferior fashion with respect thereto.

7. A driver program in accordance with any of claims 4 through 6 wherein at least one of the selection display step or steps is such that different display format is employed for at least one of the name or names associated with application information indicating at least one of the application or applications within which opening of at least one of the settings screen or screens took place versus for at least one of the name or names associated with information indicating usage within at least one of the other application or applications.

8. A driver program in accordance with claim 7 wherein the display format is such that different display densities and/or display colors are employed for at least one of the name or names associated with application information indicating at least one of the application or applications within which opening of at least one of the settings screen or screens took place versus for at least one of the name or names associated with information indicating usage within at least one of the other application or applications.

9. A driver program in accordance with any of claims 1 through 8 further comprising:
one or more frequency counting steps in which, in the event that at least one of the data processing condition settings combination or combinations displayed at at least one of the settings screen or screens is used for data processing, at least one number of times that same is used is counted; and
at least one of the selection display step or steps is such that at least one of the name or names displayed at at least one of the settings screen or screens is displayed in order of the number of times used.

10. A driver program in accordance with claim 2 wherein at least one of the save step or steps is such that it is possible for a plurality of sets of application information to be associated with any one of at least one of the data processing condition settings combination or combinations.

11. A driver program in accordance with claim 2 wherein at least one of the save step or steps further comprises:
one or more inquiry steps in which, in the event that at least one of the data processing condition settings combination or combinations is associated with application information indicating one or more applications other than any one of at least one of the application or applications requesting data processing, and at least one of the data processing condition settings combination or combinations associated with at least one of the other application or applications is used to cause execution of data processing, one or more inquiries is or are made as to whether at least one of the data processing condition settings combination or combinations is to be saved in association with application information for the one application; and in the event that in response to at least one of the inquiry or inquiries it is selected that saving is to be done in association therewith, at least one of the data processing condition settings combination or combinations, at least one of the name or names attached to at least one of the data processing condition settings combination or combinations, and at least a portion of the application information for the one application are saved to at least one of the user settings database or databases in mutually associated fashion.

12. A computer-readable recording medium on which at least one driver program according to any of claims 1 through 11 is recorded.

13. A driver control method causing execution of processing of data by way of one or more user interfaces in accordance with one or more requests from one or more applications, the driver control method comprising:
one or more information acquiring operations in which one or more user settings databases storing one or more records is or are used to acquire an application information indicating one or more applications within which opening of one or more settings screen or screens took place, at least one of the settings screen or screens appearing by way of at least one of the user interface or interfaces and permitting setting of one or more data processing conditions, and
each of at least a portion of the record or records containing, attached to one or more combinations of one or more data processing condition settings enterable or designatable at at least one of the settings screen or screens, one or more names and the application information indicating one or more applications within which setting of at least one of the data processing condition or conditions took place;
one or more selection display operations in which at least one of the user settings database or databases is searched based on the acquired application information to select and display in list form at least one of the name or names saved in association with such the application information; and
one or more settings altering operations in which one or more arbitrary names is or are selected from among at least one of the name or names displayed in list form to alter content of at least one of the data processing condition setting or settings in accordance with at least one of the combination or combinations of data processing condition setting or settings associated with such the name or names, such altered content being incorporated into at least one of the settings screen or screens.

14. A driver control apparatus causing execution of processing of data by way of one or more user interfaces in accordance with one or more requests from one or more applications, the driver control apparatus comprising:
one or more user settings databases storing one or more records;
one or more information acquiring means for acquiring an application information indicating one or more applications within which opening of one or more settings screen or screens took place, at least one of the settings screen or screens appearing by way of at least one of the user interface or interfaces and permitting setting of one or more data processing conditions, and
each of at least a portion of the record or records containing, attached to one or more combinations of one or more data processing condition settings enterable or designatable at at least one of the settings screen or screens, one or more names and the application information indicating one or more applications within which setting of at least one of the data processing condition or conditions took place;
one or more selection display means for searching at least one of the user settings database or databases based on the acquired application information and for selecting and displaying in list form at least one of the name or names saved in association with such the application information; and
one or more settings altering means for selecting one or more arbitrary names from among at least one of the name or names displayed in list form and for altering content of at least one of the data processing condition setting or settings in accordance with at least one of the combination or combinations of data processing condition setting or settings associated with such the name or names, such altered content being incorporated into at least one of the settings screen or screens.
